(19) United States
(12) Patent Application Publication
(10) Pub. No.: US 2023/0117965 A1
(43) Pub. Date: Apr. 20, 2023

(54) SOLDER COMPOSITION AND ELECTRONIC COMPONENT

(71) Applicant: TDK CORPORATION, Tokyo (JP)

(72) Inventors: Makoto ONO, Tokyo (JP); Nobuo KITAJIMA, Tokyo (JP)

(73) Assignee: TDK CORPORATION, Tokyo (JP)

(21) Appl. No.: 17/964,972

(22) Filed: Oct. 13, 2022

(30) Foreign Application Priority Data
Oct. 18, 2021 (JP) 2021-170349

(51) Int. Cl. B23K 35/26; H01B 5/00; C22C 13/00

(52) U.S. Cl. CPC B23K 35/262; H01B 5/00; C22C 13/00; B23K 2101/36

(57) ABSTRACT

Provided is a solder composition containing Sn. The composition comprises: 1.0% by mass or more and 5.0% by mass or less of Cu; 0.1% by mass or more and 0.5% by mass or less of Ni; and more than 0.01% by mass and 0.5% by mass or less of Ge.

### BACKGROUND OF THE INVENTION

### Field of the Invention

The present disclosure relates to a solder composition and an electronic component.

### Description of the Related Art

As an example of a lead-free solder that substantially does not contain lead, Sn—Cu—Ni—P—Ga system and the like are known (JP 2007-75836 A).

However, in a case where the lead-free solders are used at a high temperature of 300° C. to 450° C. when manufacturing an electronic component, or the like, at the time of soldering, there is a problem that a solder horn (a phenomenon in which the solder protrudes from a solder joint to a tip end in a horn shape) is likely to occur. Then, when the solder horn occurs, it is necessary to perform design of an electronic component and the like in consideration of the solder horn, and thus there is a problem that outer dimensions of the electronic component increase, and this not suitable for high-density mounting.

### SUMMARY OF THE INVENTION

The present disclosure has been made in consideration of such circumstances, and an object thereof is to provide a solder composition and an electronic component which are suitable for high-density mounting.

To accomplish the above object, according to an aspect of the present disclosure, there is provided a solder composition containing Sn.

The solder composition contains: 1.0% by mass or more and 5.0% by mass or less of Cu; 0.1% by mass or more and 0.5% by mass or less of Ni; and more than 0.01% by mass and 0.5% by mass or less of Ge.

When the solder composition of the present disclosure contains Sn, and further contains Cu, Ni, and Ge, it is possible to realize a lead-free solder composition that substantially does not contain lead. In addition, according to the solder composition of the present disclosure, occurrence of a solder horn can be suppressed at the time of soldering in a high-temperature region (for example, 300° C. to 450° C.). Since occurrence of the solder horn is suppressed, it is possible to prevent short-circuiting due to contact of the solder horn with another terminal portion (another circuit pattern or another electronic component) or the like, and the like.

Furthermore, since the solder horn is reduced, it is not required to lengthen a mounting portion of a terminal in consideration of the solder horn, and it is easy to decrease a size of an electronic component including the mounting portion of the terminal. Accordingly, high-density mounting of the electronic component becomes easy. For example, in a case where the solder horn occurs, when connecting a lead of a wire to the connection portion of the terminal with the solder composition, it is required to lengthen the mounting portion of the terminal located on a downward side of the connection portion in comparison to the connection portion in consideration of the solder horn.

Since the solder horn can be reduced by using the solder composition of the present disclosure, a length of the mounting portion of the terminal in the electronic component can be shortened, and a size of the electronic component including the mounting portion of the terminal can be reduced. In addition, inspection on a mounting state at the mounting portion of the terminal becomes easy, and it is easy to cope with automatic mounting inspection, thereby contributing to automation of inspection and cost reduction of the electronic component.

It is possible to reduce solder balls which are scattered to the periphery when heating the solder at a high temperature. For example, it is possible to effectively prevent short-circuiting with another circuit or short-circuiting between electronic components due to scattering of the solder balls to another circuit pattern or electronic component. Accordingly, the solder composition can be preferably used in high-density mounting of the electronic component. In addition, the solder composition can be preferably used in mounting at a high temperature.

According to the solder composition, even when being used in the lead portion of the wire, it is possible to effectively suppress a wire thinning phenomenon in which a metal such as copper in the wire is dissolved in the solder, and the wire becomes thin.

Preferably, the solder composition further contains 0.001% by mass to 0.5% by mass of P. In addition, more preferably, the solder composition further contains 0.001% by mass to 0.5% by mass of Ga. In the solder composition, the scattering of the solder balls can be further suppressed. In addition, oxidation of the solder can be effectively prevented.

According to another aspect of the present disclosure, there is provided an electronic component including a solder portion containing the above solder composition. In addition, the electronic component may include a terminal electrode, the terminal electrode may include a connection portion to which a lead portion of a wire is connected, and the lead portion may be electrically connected to the connection portion at the solder portion. In addition, the lead portion of the wire may be entangled into the connection portion.

The terminal electrode may further include a mounting portion, and the connection portion may be disposed on a side opposite to a mounting side in comparison to the mounting portion. In the solder portion using the solder composition according to the aspect of the present disclosure, the solder horn can be reduced at the time of soldering in a high-temperature region of 300° C. to 450° C. Accordingly, even when the connection portion is disposed on an upper side of the mounting portion, a length of the mounting portion can be set to a necessary minimum length, and a joint state (for example, a solder joint) of the mounting portion can be observed with a camera for automatic mounting inspection from an upper side of the connection portion, and thus appropriateness for automatic mounting inspection is realized.

### BRIEF DESCRIPTION OF THE DRAWINGS

FIG. 1A is a schematic front view of an electronic component according to an embodiment of the present disclosure;

FIG. 1B is an enlarged view of a main section of the electronic component illustrated in FIG. 1A;

FIG. 2 is a top view of the electronic component shown in FIG. 1A;

FIG. 3 is a schematic perspective view of an electronic component according to another embodiment of the present disclosure;

FIG. 4 is a schematic view related to measurement on a solder length;

FIG. 5A is a graph illustrating a variation in a distance between connection portions of terminal electrodes before and after solder connection of a coil device according to an example of the present disclosure;

FIG. 5B is a graph illustrating a variation in a distance between connection portions of terminal electrodes before and after solder connection of a coil device according to a comparative example of the present disclosure;

FIG. 6 is a graph illustrating a relationship between solder dipping time and a wire diameter variation according to an example and a comparative example of the present disclosure;

FIG. 7A is a cross-sectional view of a device related to evaluation on the amount of solder balls;

FIG. 7B is a top view of the device related to evaluation on the amount of solder balls shown in FIG. 7A; and

FIG. 8 is a schematic view illustrating an adhesion state of the solder balls related to evaluation on the amount of solder balls.

### DETAILED DESCRIPTION OF THE PREFERRED EMBODIMENTS

Hereinafter, the present disclosure is described based on embodiments shown in the drawings.

### First Embodiment

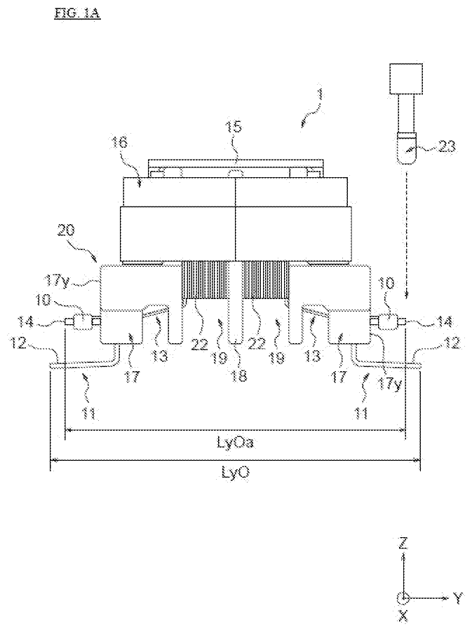

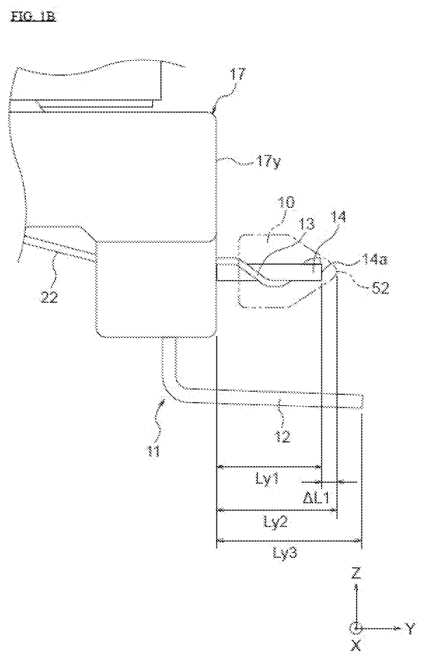

As shown in FIG. 1A, a coil device 1 as an electronic component according to an embodiment of the present disclosure includes two coil portions 19, and functions as a transformer. Each of the coil portions 19 is formed by winding a wire 22 around a bobbin portion 20. A middle leg portion (not illustrated) of a core portion 16 is inserted into a shaft of each of the coil portions 19. The coil portions 19 are separated from each other by a flange portion 18. A cover plate 15 is attached to an upper portion of the coil portions 19.

A wire that constitutes the coil portion 19 and is connected to each terminal portion is not particularly limited. For example, conductive wires such as copper, a copper alloy, iron, an iron alloy, and a CP wire may be used. Although not particularly limited, as an insulating material that constitutes an insulating coat that coats the wire, urethane, polyamideimide, and ETFE can be used.

Although not particularly limited, a material of the core portion 16 may be a magnetic material, and the material is constituted by a ferrite composition, a metal composition, a composite composition thereof with a resin. The core portion 16 may be produced by a method such as firing after compression molding, and typical compaction molding.

The bobbin portion 20 is molded, for example, by an injection molding, and a material thereof is not particularly limited and is constituted, for example, by PBT, PET, LCP, PA, or a phenolic resin from the viewpoint of heat resistance. The cover plate 15 can be constituted by the same material as in the bobbin, but may be constituted by an insulating member other than a resin. The bobbin portion 20 can also be constituted by the insulating member other than a resin as long as the insulating member can be molded.

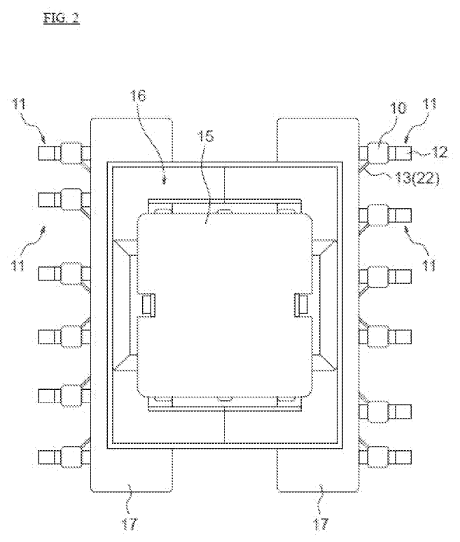

Terminal blocks 17 are formed integrally with both ends of the bobbin portion 20 in a Y-axis direction, respectively. As shown in FIG. 2, a plurality of terminal electrodes 11 arranged in parallel along an X-axis direction are insert-molded into each of the terminal blocks 17.

As shown in FIG. 1A, each of the terminal electrodes 11 has a U-shape including a mounting portion 12 and a connection portion 14. The connection portion 14 protrudes from an end surface 17y of the terminal block 17 toward an outer side, in other words, toward an outer side in the Y-axis direction. The mounting portion 12 extends from a bottom surface of the terminal block 17 to a downward side in a Z-axis direction, and protrudes toward a downward side in the Y-axis direction. The mounting portion 12 slightly further protrudes toward the outer side in the Y-axis direction in comparison to the connection portion 14. The connection portion 14 is disposed on a side (upper side) opposite to a mounting side along the Z-axis in comparison to the mounting portion 12. In the drawings, the X-axis, the Y-axis, and the Z-axis are orthogonal to each other.

As shown in FIG. 1B, a lead portion 13 of the wire 22 is entangled into the connection portion 14. A solder portion 10 is formed to cover the lead portion 13 and the connection portion 14. The connection portion 14 and the lead portion 13 are electrically connected by the solder portion 10.

The solder portion 10 is constituted by a solder composition, and may contain flux or another component. The solder composition of this embodiment substantially does not contain lead. A liquid phase temperature of the solder composition of this embodiment is lower than a temperature at the time of soldering, and is, for example, 220° C. to 380° C. In this embodiment, with regard to description of “substantially does not contain lead”, a lead content ratio in the solder composition is preferably 0.10% by mass or less, more preferably 0.05% by mass or less, and still more preferably 0.01% by mass or less.

The solder composition of this embodiment contains Sn as a main component. Although not particularly limited, the amount of Sn contained in the solder composition is preferably 90% by mass or more, more preferably 93% by mass or more, and still more preferably 94% by mass or more. In the case of the range, a lead-free solder composition is likely to be realized.

The amount of Cu contained in the solder composition of this embodiment is 1.0% by mass or more and 5.0% by mass or less, preferably 2.0% by mass or more, and more preferably 2.5% by mass or more. The amount of Cu is preferably 3.5% by mass or less. In this range, a thinning of a wire diameter in the wire can be suppressed without deterioration of solderability.

The amount of Ni contained in the solder composition of this embodiment is 0.1% by mass or more and 0.5% by mass or less, preferably 0.15% by mass or more, and more preferably 0.2% by mass or more. The amount of Ni is preferably 0.4% by mass or less, and more preferably 0.3% by mass or less. In this range, a thinning of the wire diameter can be suppressed.

In this embodiment, the total amount of Cu and Ni is preferably more than 1.2% by mass, more preferably 2.0% by mass or more, and still more preferably 3.0% by mass or more.

The amount of Ge contained in the solder composition of this embodiment is more than 0.01% by mass and 0.5% by mass or less, preferably 0.015% by mass or more, more preferably 0.02% by mass or more, still more preferably 0.04% by mass or more, and still more preferably 0.05% by mass or more. The amount of Ge is preferably 0.3% by mass or less, more preferably 0.1% by mass or less, and still more preferably 0.08% by mass or less. In this range, the solder horn is reduced.

The amount of P contained in the solder composition of this embodiment may be substantially zero, but the amount of P is preferably more than 0.001% by mass and 0.5% by mass or less, more preferably 0.01% by mass or more, and still more preferably 0.02% by mass or more. The amount of P is preferably 0.3% by mass or less, and more preferably 0.1% by mass or less. In this range, the scattering of solder balls is reduced.

In this embodiment, since the solder composition contains Sn, and further contains Cu, Ni, and Ge, a lead-free solder composition that substantially does not contain lead can be obtained. In this embodiment, a solder horn can be reduced at the time of soldering in a high-temperature region (for example, 300° C. to 450° C.). Since the solder horn is reduced, it is possible to prevent short-circuiting due to contact of the solder horn with another terminal portion (another circuit pattern or another electronic component).

Since the solder horn is reduced, it is not required to lengthen the mounting portion 12 of the terminal electrode 11 along the Y-axis in consideration of the solder horn as shown in FIG. 1B. Accordingly, it is easy to reduce a total length Ly0 of the coil device 1 including the mounting portion 12 of the terminal electrode 11 shown in FIG. 1A along the Y-axis. Accordingly, high-density mounting of the coil device 1 becomes easy.

For example, as shown in FIG. 1B, in a case where the solder horn occurs in a solder tip end 52 of the solder portion 10 that protrudes from a tip end 14a of the connection portion 14 of the terminal electrode 11 to an outer side along the Y-axis, a solder length AT 1 is lengthened. Therefore, when connecting the solder portion 10 formed from the solder composition and the lead portion 13 of the wire 22 to the connection portion 14 of the terminal electrode 11, it is necessary to further lengthen the mounting portion 12 of the terminal electrode 11 located on a downward side of the connection portion 14 in comparison to the connection portion 14 along the Y-axis in consideration of the solder horn.

That is, it is necessary to further lengthen a length Ly3 of the mounting portion 12 from the end surface 17y of the terminal block 17 along the Y-axis in comparison to a length Ly2 obtained by adding the solder length ΔL1 to a length Ly1 from the end surface 17y of the connection portion 14 along the Y-axis. The reason for this is as follows. Otherwise, the solder tip end 52 shown in FIG. 1B becomes an obstacle, and as shown in FIG. 1A, it is difficult to observe a mounting state of the mounting 12 with a camera 23 located on a further upper side of the connection portion 14 along the Z-axis. That is, automatic inspection as to whether or not a tip end of the mounting portion 12 along the Y-axis is joined to a circuit pattern such as a circuit board (not illustrated) becomes difficult.

In the solder portion 10 formed from the solder composition of this embodiment, since the solder horn can be suppressed, the length Ly2 of the solder tip end from the end surface 17y of the terminal block can be shortened. Accordingly, the length Ly3 of the mounting portion 12 of the terminal electrode 11 as shown in FIG. 1B can be shortened, and the length (particularly, a distance between the terminal electrodes 11) Ly0 of the coil device 1 including the mounting portion 12 of the terminal electrode 11 along the Y-axis as shown in FIG. 1A can be reduced. In addition, inspection of the mounting state in the mounting portion 12 of the terminal electrode 11 becomes easy, and it is easy to cope with automatic mounting inspection, thereby contributing to automation of inspection and cost reduction of the coil device 1.

In this embodiment, it is possible to suppress solder balls which are scattered to the periphery when heating the solder (solder composition) constituting the solder portion 10 at a high temperature. For example, it is possible to effectively prevent short-circuiting with another circuit or short-circuiting between a plurality of the coil devices 1 due to scattering of the solder balls to another circuit pattern or electronic component. Accordingly, the solder composition of this embodiment can be preferably used in high-density mounting of the coil device 1. In addition, the solder composition can be preferably used in mounting at a high temperature.

According to the solder composition that constitutes the solder portion 10 of this embodiment, even when being used for the lead portion 13 of the wire 22, it is possible to effectively suppress a wire thinning in which a metal such as copper in the wire 22 is dissolved in the solder, and the lead portion 13 becomes thin. Accordingly, reliability of mechanical and electrical connection between the lead portion 13 and the connection portion 14 is improved.

Note that, a liquid phase temperature (or a melting point) of the solder when connecting the mounting portion 12 of the terminal electrode 11 to the circuit board is preferably equal to or lower than a liquid phase temperature (or a melting point) of the solder composition of this embodiment.

Another component, for example, Ag, Zn, Sb, and Au may be contained in the solder composition of this embodiment in a range not deteriorating the effect of the solder composition. Unavoidable impurities can be also contained in the solder composition of this embodiment. The less the unavoidable impurities, the more preferable, and a total amount of the unavoidable impurities is more preferably set to 1% by mass or less.

### Second Embodiment

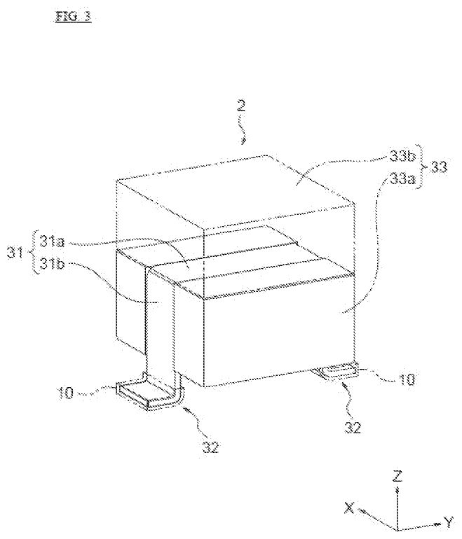

As shown in FIG. 3, a coil device 2 of this embodiment functions, for example, as a surface-mounting type inductor of a power supply circuit. The coil device 2 includes a core 33 and a coil 31, a mounting portion 32 is formed in the coil 31, and the solder portion 10 is formed on a surface of the mounting portion 32. The configuration of the solder portion 10 is similar as in the above embodiment, and thus the same operational effect can be obtained.

As shown in FIG. 3, the core 33 includes a main core 33a having a substantially rectangular parallelepiped shape and a sub-core 33b that has a substantially rectangular parallelepiped shape and is disposed on an upper side of the main core 33a in the Z-axis direction.

The coil 31 is obtained by press-forming a plate-shaped conductor. An intermediate coil portion 31a of the coil 31 linearly extends in the Y-axis direction. Both ends of the intermediate coil portion 31a in the Y-axis direction are connected to end coil portions 31b, respectively. The end coil portions 31b linearly extends downward in the Z-axis direction. A mounting portion 32 that extends to a lower side in the Z-axis direction, and is bent outward in the Y-axis direction is formed at a lower end of each of the end coil portions 31b in the Z-axis direction.

The intermediate coil portion 31a is sandwiched between the cores 33a and 33b, and is disposed in a groove that is formed in an upper surface of the main core 33a in the Z-axis direction and linearly extends in the Y-axis direction. In this embodiment, the upper surface of the main core 33a in the Z-axis direction is fixed to and integrated with a bottom surface of the sub-core 33b in the Z-axis direction with an adhesive (not illustrated), and thus the intermediate coil portion 31a of the coil 31 is sandwiched between the surfaces. The end coil portions 31b are disposed in grooves that are formed in both end surfaces of the main core 33a in the Y-axis direction and linearly extend downward in the Z-axis direction.

Although not particularly limited, for example, a metal such as copper, a copper alloy, silver, and gold are used as the plate-shaped conductor that constitutes the coil 31 and the mounting portion 32. For example, a surface of the plate-shaped conductor is subjected to metal plating. Example of the metal plating include nickel plating, tin plating, solder plating, silver plating, and the plating may be a single layer or a multi-layer. The metal plating is preferably formed on at least a mounting surface of the mounting portion 32 on the surface of the plate-shaped conductor.

The solder portion 10 is formed on the surface of the mounting portion 32. Although not particularly limited, examples of a method of forming the solder portion 10 include a dipping method, a reflow method. Note that, the solder portion 10 may be formed after assembling the coil device 2, may be formed before assembling the coil device 2, or may be formed when connecting the coil device 2 to a circuit board.

Note that, the present invention is not limited to the above embodiments, and may be modified in various manners within the scope of the present disclosure.

For example, as the electronic component in which the solder composition of the present invention is used, application can be made to coil devices for other usages, or other electronic components including a terminal electrode, for example, a capacitor, a varistor, or a resistive element without limitation to the coil device such as a transformer.

### EXAMPLES

Hereinafter, the present disclosure will be further described with reference to detailed examples, but the present invention is not limited to the examples.

Examples and Comparative Examples A solder composition was adjusted by mixing various elements. Various solder materials obtained by mixing various solder compositions and a flux (SR-209, manufactured by SENJU METAL INDUSTRY CO., LTD.) were adjusted. Content ratios of components in each of the solder compositions are shown in Table 1 to Table 3. Evaluation on the solder composition was performed by the following method.

[Measurement of Solder Length]

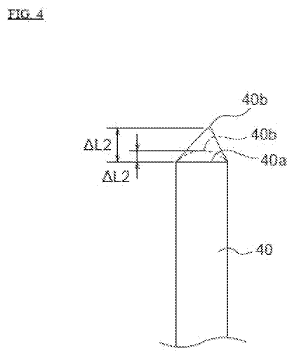

As shown in FIG. 4, a test wire 40 constituted by a cooper wire (AIEIW) that is insulation-coated and has an outer diameter of 1.0 mm was prepared, and was polished so that a wire tip end 40a becomes flat. Various solder materials were heated at a temperature that is equal to or higher than a liquid phase temperature and is equal to or lower than 440° C. The wire tip end 40a was immersed toward a downward side of a vertical axis from a direction orthogonal to a solder installation surface, and the wire tip end 40a was pulled up in an opposite direction at a rate of 1 to 15 mm/s and was cooled down.

As shown in FIG. 4, a solder length ΔL 2 (mm) from the wire tip end 40a to the solder tip end 40b was measured. This process was performed four times while changing a wire to obtain a maximum value and a minimum value of the solder length AT 2. The maximum value and the minimum value are shown in Table 1.

TABLE 1

| | | | | | | | | Solder |
|---|---|---|---|---|---|---|---|---|
| | Chemical composition, wt % | | | | | | | length, |
| | Sn | Cu | Ag | Ni | Ge | Ga | P | mm |
| Example 1 | Remainder | 3 | — | 0.25 | 0.07 | — | — | 0.2-0.4 |
| Example 2 | Remainder | 3 | — | 0.25 | 0.07 | 0.01 | 0.01 | 0.2-0.4 |
| Example 3 | Remainder | 3 | — | 0.15 | 0.07 | — | — | 0.2-0.4 |
| Example 4 | Remainder | 3 | — | 0.35 | 0.07 | — | — | 0.2-0.4 |
| Example 5 | Remainder | 5 | — | 0.25 | 0.07 | — | — | 0.2-0.4 |
| Example 6 | Remainder | 3 | — | 0.25 | 0.04 | — | — | 0.2-0.4 |
| Example 7 | Remainder | 3 | — | 0.25 | 0.02 | — | — | 0.2-0.4 |
| Comparative | Remainder | 6 | 2 | — | — | — | — | 0.5-0.9 |
| Example 1 | | | | | | | | |
| Comparative | Remainder | 5 | — | 0.15 | — | 0.01 | 0.01 | 0.5-0.9 |
| Example 2 | | | | | | | | |
| Comparative | Remainder | 3 | — | 0.25 | 0.01 | — | — | 0.5-0.8 |
| Example 3 | | | | | | | | |
| Comparative | Remainder | 3 | — | 0.25 | 0.005 | — | — | 0.5-0.8 |
| Example 4 | | | | | | | | |
| Comparative | Remainder | 3 | — | 0.25 | — | — | — | 0.5-0.9 |
| Example 5 | | | | | | | | |
| Example 11 | Remainder | 3 | — | 0.5 | 0.07 | — | — | 0.2-0.6 |
| Example 12 | Remainder | 3 | — | 0.1 | 0.07 | — | — | 0.2-0.6 |
| Example 13 | Remainder | 3 | — | 0.25 | 0.5 | — | — | 0.2-0.6 |
| Example 14 | Remainder | 3 | — | 0.25 | 0.3 | — | — | 0.2-0.6 |
| Example 15 | Remainder | 1 | — | 0.25 | 0.07 | — | — | 0.2-0.6 |

As shown in Table. 1, in Examples 1 to 7 in which the amounts of respective components contained were within a predetermined range, the solder length AT 2 was 0.2 to 0.4 mm in any of the examples. In addition, as indicated by a two-dotted line in FIG. 4, in Examples 1 to 7, the solder end portion 52 was gently rounded, and a solder horn hardly occurred.

In Comparative Examples 1 to 5 in which the amount of Ni or Ge is out of the predetermined range, the minimum value of the solder length ΔL 2 (mm) was 0.5 mm, and the maximum value was 0.9 mm. In Comparative Examples 1 to 5, as indicated by a solid line in FIG. 4, the solder tip end 40b became a conical shape, and occurrence of the solder horn was confirmed.

In Examples 11 to 15, the solder length ΔL2 was 0.2 to 0.7 mm, and the solder length AT 2 was inferior to Examples 1 to 7 but was superior to Comparative Examples 1 to 5. As indicated by a two-dotted chain line in FIG. 4, even in Examples 11 to 15, the solder end portion 52 was gently rounded and the solder horn hardly occurred.

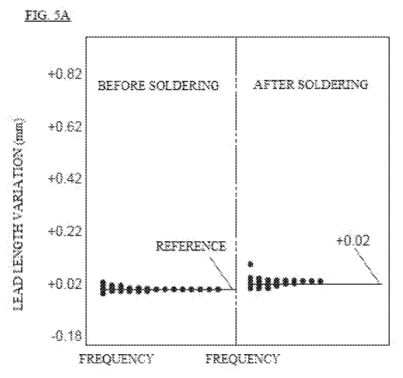

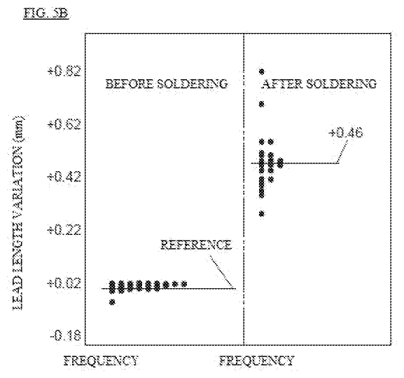

The solder portion 10 of the coil device 1 as shown in FIG. 1A was actually formed by using the above solder composition of Example 1. A distance (lead length) LyOa between the connection portions 14 located on both outer ends of the Y-axis in a state of also including the solder portion 10 was measured to investigate a variation (mm) in length before and after soldering. Measurement was performed with respect to twenty pairs of the connection portions 14 for test, and the frequency and the length variation were measured. Results are shown in FIG. 5A. In FIG. 5A, the horizontal axis represents the frequency and the vertical axis represents the length variation.

In the same manner, the solder portion 10 of the coil device 1 as shown in FIG. 1A was actually formed by using the solder composition of Comparative Example 1. The distance (lead distance) LyOa between the connection portions 14 located on both outer ends of the Y-axis in a state of also including the solder portion 10 was measured to investigate the variation (mm) in length before and after soldering. Measurement was performed with respect to twenty pairs of the connection portions 14 for test, and the frequency and the length variation were measured. Results are shown in FIG. 5B.

As shown in FIG. 5A and FIG. 5B, in Example 1, it could be confirmed that the lead length variation was significantly smaller in comparison to Comparative Example 1.

[Evaluation on Wire Thinning]

Two types of polyurethane copper wires (2UEW, ϕ: 0.16) having an outer diameter of 0.16 mm were prepared. A plurality of wires were immersed for 10 seconds in a solder material obtained by heating a solder material formed from each of the solder compositions of Example 2, Comparative Example 6, and Comparative Example 7, and the flux at 405° C. to 415° C. A wire diameter of the wires after immersion was measured, a reduction rate from a wire diameter before immersion was obtained, and the reduction rate was set as wire thinning. Results are shown in Table 2.

TABLE 2

| | | | | | | | | Wire |
|---|---|---|---|---|---|---|---|---|
| | Chemical composition, wt % | | | | | | | thinning, |
| | Sn | Cu | Ag | Ni | Ge | Ga | P | % |
| Example 2 | Remainder | 3 | — | 0.25 | 0.07 | 0.01 | 0.01 | 7 |
| Comparative | Remainder | 3 | — | 0.05 | 0.01 | — | — | 33 |
| Example 6 | | | | | | | | |
| Comparative | Remainder | 3 | — | — | 0.07 | 0.01 | 0.01 | 40 |
| Example 7 | | | | | | | | |

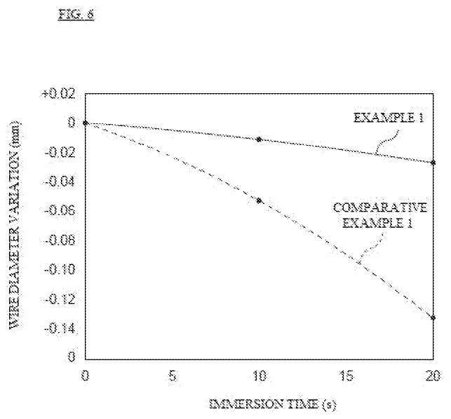

As shown in Table 2, in Example 2, it was confirmed that wire thinning was greatly suppressed in comparison to Comparative Examples 6 and 7. To reduce the wire thinning, it is expected that at least Ni is preferably contained in the solder composition in a predetermined ratio or more. Note that, a relationship between immersion time and wire diameter in a case of using the solder compositions of Example 1 and Comparative Example 1 is shown in FIG. 6.

[Evaluation on Amount of Solder Balls]

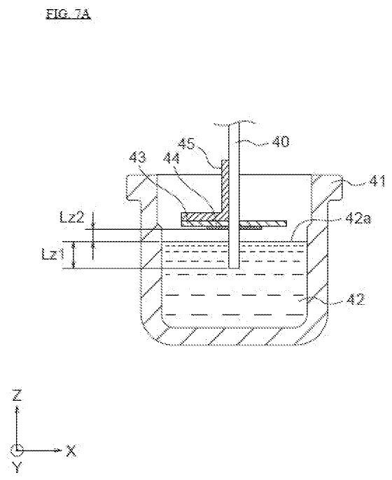

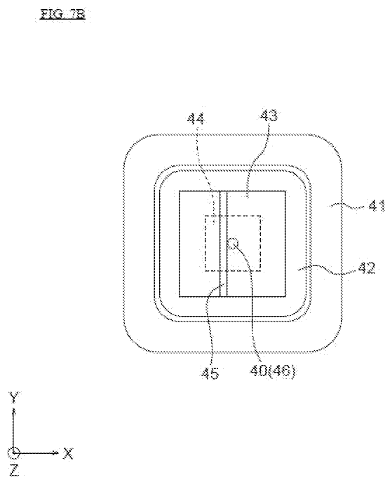

As shown in FIG. 7A and FIG. 7B, a substrate 43 having dimensions of 40×40 mm square was prepared, and a double-sided tape 44 having dimensions of 20×25 mm square was attached to the central lower surface of the substrate 43. A test wire 40 obtained by twisting 1000 pieces of two types of polyurethane copper wires (2UAE) having an outer diameter of 0.05 mm was allowed to pass through a through-hole 46 formed in the center of the substrate.

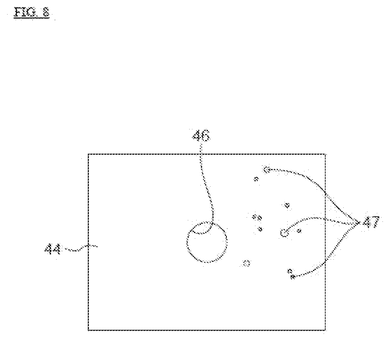

Before or after the process, a solder tank 41 accommodating a solder bath 42 containing the solder composition of each of Example 1, Example 2, and Comparative Example 1 as shown in FIG. 7A was prepared. The wire 40 and the substrate 43 were fixed to a holder 45. The wire 40 was immersed in the solder bath 42 set to a temperature of 380° C. to 390° C. at a position where an immersion depth Lz1 becomes 10 mm. A distance Lz2 from a solder surface of the double-sided tape 44 becomes 5 mm for five seconds, thereby attaching the solder to the tip end of the wire 40. As the flux, SR-209 manufactured by SENJU METAL INDUSTRY CO., LTD. was used. The number of solder balls attached to the surface of the double-sided tape 44 as shown in FIG. 8 was counted. The test was performed four times, and an average value was obtained. The results are shown in Table 3.

TABLE 3

| | | | | | | | | Number of |
|---|---|---|---|---|---|---|---|---|
| | Chemical composition, wt % | | | | | | | solder balls, |
| | Sn | Cu | Ag | Ni | Ge | Ga | P | pieces |
| Example 2 | Remainder | 3 | — | 0.25 | 0.07 | 0.01 | 0.01 | 2.5 |
| Comparative | Remainder | 6 | 2 | — | — | — | — | 24 |
| Example 1 | | | | | | | | |
| Example 1 | Remainder | 3 | — | 0.25 | 0.07 | — | — | 15 |

As shown in Table 3, it could be confirmed that the solder balls were further suppressed in Example 1 and Example 2 in which the amount of each component contained is within the predetermined range in comparison to Comparative Example 1 in which Ni and Ge are not contained as shown in Table 3.

### EXPLANATIONS OF LETTERS OR NUMERALS

1, 2 COIL DEVICE
10 SOLDER PORTION
11 TERMINAL ELECTRODE
12 MOUNTING PORTION
13 LEAD PORTION
14 CONNECTION PORTION
15 COVER PLATE
16 CORE PORTION
17 TERMINAL BLOCK
18 FLANGE PORTION
19 COIL PORTION
20 BOBBIN PORTION
22 WIRE
23 CAMERA
31 COIL
31a INTERMEDIATE COIL PORTION
31b END COIL PORTION
32 MOUNTING PORTION
33 CORE
33a MAIN CORE
33b SUB-CORE
40 TEST WIRE
40a WIRE TIP END
40b SOLDER TIP END
41 SOLDER TANK
42 SOLDER BATH
42a SOLDER SURFACE
43 SUBSTRATE
44 DOUBLE-SIDED TAPE
45 HOLDER
46 THROUGH-HOLE
47 SOLDER BALL

What is claimed is:

1. A solder composition containing Sn, comprising:
1.0% by mass or more and 5.0% by mass or less of Cu;
0.1% by mass or more and 0.5% by mass or less of Ni; and
more than 0.01% by mass and 0.5% by mass or less of Ge.

2. The solder composition according to claim 1, further comprising:
0.001% by mass or more and 0.5% by mass or less of P.

3. The solder composition according to claim 1, further comprising:
0.001% by mass or more and 0.5% by mass or less of Ga.

4. An electronic component, comprising:
a solder portion containing the solder composition according to claim 1.

5. The electronic component according to claim 4, further comprising:
a terminal electrode,
wherein the terminal electrode includes a connection portion to which a lead portion of a wire is connected, and
the lead portion is electrically connected to the connection portion by the solder portion.

6. The electronic component according to claim 5,
wherein the lead portion of the wire is entangled into the connection portion.

7. The electronic component according to claim 5,
wherein the terminal electrode further includes a mounting portion, and
the connection portion is disposed on a side opposite to a mounting side in comparison to the mounting portion.
